(19) United States
(12) Patent Application Publication
(10) Pub. No.: US 2022/0335545 A1
(43) Pub. Date: Oct. 20, 2022

(54) SYSTEM AND METHOD FOR ESTIMATING ELECTRIC VEHICLE CHARGE NEEDS AMONG A POPULATION IN A REGION

(71) Applicant: Volta Charging, LLC, San Francisco, CA (US)

(72) Inventors: David J. Klein, Los Altos, CA (US); Anna C.J. Bailey, San Francisco, CA (US); Praveen K. Mandal, San Francisco, CA (US); Han-En Eric Kung, Livermore, CA (US)

(21) Appl. No.: 17/725,455

(22) Filed: Apr. 20, 2022

Related U.S. Application Data
(60) Provisional application No. 63/177,342, filed on Apr. 20, 2021.

(51) Int. Cl. G06Q 50/06; G06Q 30/02

(52) U.S. Cl. CPC G06Q 50/06; G06Q 30/0202; G06Q 30/0205

(57) ABSTRACT

An approach is provided for estimating electric vehicle (EV) charge needs among a population in a particular region. A method includes obtaining region-specific information associated with the particular region; wherein the region-specific information includes a number of EV drivers in the particular region. The method includes generating needs prediction data that indicates the EV charge needs among the population by applying the region-specific information to a mobility simulation of electrical vehicle drivers in the particular region; wherein the mobility simulation comprises a plurality of probability distribution functions. The method includes generating, based on the needs prediction data, on a display device of a computing device, a display that suggests a plurality of locations at which to place EV charging stations within the particular region to satisfy the estimated EV charge needs indicated in the needs prediction data.

### BENEFIT CLAIM

This application claims the benefit of provisional application 63/177,342, filed Apr. 20, 2021, by David J. Klein et al., the entire contents of which is hereby incorporated by reference as if fully set forth herein, under 35 U.S.C. § 119(e).

### FIELD OF THE INVENTION

The techniques described herein relate to software tools for demand estimation, and more specifically, to systems and methods for providing electric vehicle charging station (EVCS) infrastructure deployment recommendations to satisfy estimated EVCS demand.

### BACKGROUND

The adoption of plug-in electric vehicles (EVs), including fully electric vehicles (also referred to as EVs) and plug-in hybrid electric vehicles (PHEVs), continues to accelerate at a rapid pace. For example, it is estimated that the total cost of ownership for EVs will reach parity with traditional internal combustion engine (ICE) vehicles in 2022 for large vehicles and 2024 for small and mid-size vehicles, thereby encouraging EV adoption as the relative costs of EVs continue to drop compared to ICE vehicles. The adoption of EVs provides many benefits for drivers and the general population, including but not limited to: reduced harmful emissions and noise pollution, lower vehicle maintenance costs, and reduced exposure to supply chain disruptions, geopolitical risks, and other factors affecting fuel prices.

To meet the growing demands of EV drivers, charging infrastructure needs to be carefully deployed in an intelligent and efficient manner to meet both current and future charging needs. Various stakeholders such as utilities, municipalities, industry stakeholders, business owners, and other parties will benefit from combined insights on EV adoption, EV driving and charging patterns, regional demographics, point of interest (POI) visitation, impact measurements, and other factors to plan for EV charging infrastructure deployment. Current approaches do not address these factors in an integrated and holistic manner. Thus, an improved approach for planning EV charging infrastructure is needed.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Implementations are depicted by way of example, and not by way of limitation, in the figures of the accompanying drawings and in which like reference numerals refer to similar elements.

FIG. 1 is a block diagram that depicts a system for providing a software tool for predicting EV adoption and planning electric vehicle charging station (EVCS) infrastructure deployment, according to an implementation.

FIG. 2A is a diagram that depicts charts of adoption over time using a Generalized Bass diffusion model (“Bass model”).

FIG. 2B is a block diagram that depicts a computation of EV sale limits and POI sales lift for a region, according to an implementation.

FIG. 2C is a block diagram that depicts projection of future sales using a Bass model, according to an implementation.

FIG. 2D is a block diagram that depicts estimation of EV adoption, according to an implementation.

FIG. 2E is a diagram that depicts an example user interface for displaying current and estimated EV adoption, according to an implementation.

FIG. 3A is a diagram that depicts probability distributions of distance and commute times prior to arrival at a POI for use in a mobility simulation, according to an implementation.

FIG. 3B is a diagram that depicts a chart for categorizing commuters into defined mobility motifs for use in a mobility simulation, according to an implementation.

FIG. 4A is a diagram that depicts an example two-layer multilayer perceptron (MLP) neural network for predicting visitation to a POI, according to an implementation.

FIG. 4B is a diagram that depicts an example user interface for displaying current and estimated visitation to a POI, according to an implementation.

FIG. 4C is a diagram that depicts an example user interface for displaying charger type usage and hourly visitation to a POI, according to an implementation.

FIG. 4D is a diagram that depicts an example user interface for displaying EVCS recommendations and energy usage for a POI, according to an implementation.

FIG. 4E is a diagram that depicts an example user interface for displaying a ranking of POIs for EVCS deployment, according to an implementation.

FIG. 5 is a block diagram that depicts estimated harm reduction from EV adoption, according to an implementation.

FIG. 6A is a flow diagram that depicts an approach for providing electric vehicle charging station (EVCS) infrastructure deployment recommendations by estimating EV charge needs among a population in a region.

FIG. 6B is a flow diagram that depicts an approach for providing estimated EVCS demand at a POI.

FIG. 6C is a flow diagram that depicts an approach for providing an estimated optimal number and mixture of types of EVCS at one or more POIs.

FIG. 7 is a block diagram that depicts an example computer system upon which embodiments may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

I. Overview

II. Architecture

III. Estimating EV Adoption
A. Economic Lift for POI with EVCS
B. Bass Model EV Sales Predictor
C. User Interface for EV Adoption

IV. Mobility Simulation for Predicting Commutes

V. Inference Engine with Visitation Model for Determining Optimal EVCS Mix

VI. Measuring Impact Metrics

VII. Implementation Processes
A. Providing EVCS Deployment Recommendations
B. Providing Estimated EVCS Demand at a POI
C. Providing Estimated Optimal EVCS Mix at POIs

VIII. Hardware Overview

### I. Overview

A machine-learning based software tool is provided to predict EV adoption and demand, provide recommendations for deployment of EV charging infrastructure, and measure the various impacts of EV adoption. The tool can be used by utilities, municipalities, industry stakeholders, business owners, and other parties to make informed decisions regarding the makeup and deployment of EVCS within regions, at POIs, or along traffic corridors. The tool can be used interactively to optimize for various factors such as charger utilization, economic and visitation uplift, environmental and societal impacts, and harm reduction.

The tool can be used to provide recommendations for a specific geographic region or area. In one implementation, the region can be defined by using boundaries that correspond to a city, county, state, prefecture, country, or other geographic region. In another implementation, the region can be defined by selecting a specific geographic coordinate, such as latitude and longitude, and specifying a shape around the geographic coordinate, such as a circle with a defined radius. In yet another implementation, the region can be defined by selecting a traffic corridor, which may include the traffic corridor itself and surrounding areas.

Once a region is selected, region-specific information including a number of EV drivers is obtained. The number of EV drivers may be derived based on an EV adoption model using the region-specific information. Prediction data indicating EV charge needs is generated based on a mobility simulation of EV drivers in the region. In one implementation, the mobility simulation includes multiple probability distribution functions. Based on the prediction data, suggestions and recommendations are made as to where to place EV charging stations within the region to satisfy the EV charge needs.

Further, by selecting a POI associated with an existing EVCS or a proposed EVCS site, a classification of drivers may be used to estimate charging demand at the POI. The classification may use data from the mobility simulation to classify drivers as either “essential drivers” or “opportunistic drivers” with respect to charging behavior. The classification may be further processed through an inference engine, implementable via a neural network, to determine and display optimal types and quantities of chargers to minimize waiting time at the EVCS. The inference engine may also optimize for other factors, such as optimizing power draw for energy grid considerations, targeting a minimum or average (mean) dwell time to encourage drivers to patronize nearby businesses at the POI, minimizing particulate matter emissions, noise pollution, and other externalities for harm reduction, or maximizing positive environmental and societal impacts.

A visitation model may also be generated for the selected POI. The visitation model models the drivers predicted to visit the POI at various times of the day, such as on an hourly basis, as well as driver commute times prior to reaching the POI. By applying queuing theory to the visitation model and combining with the EV adoption model, mobility simulation, and inference engine, a specific and optimal mix of charging station types can be formulated for supplementing an existing EVCS site or proposing a new EVCS site at the POI. The deployment recommendations can be configured according to current or future projected demand to support both current and future EVCS infrastructure requirements.

### II. Architecture

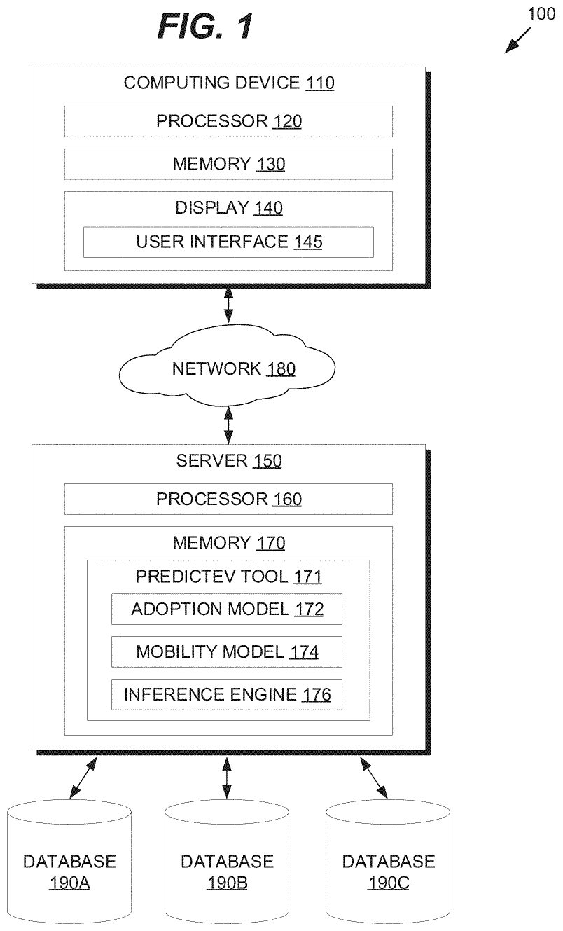

FIG. 1 is a block diagram that depicts a system 100 for providing PredictEV tool 171, a software tool for predicting EV adoption and planning electric vehicle charging station (EVCS) infrastructure deployment, according to an implementation. System 100 includes computing device 110, server 150, network 180, database 190A, database 190B, and database 190C. Computing device 110 includes processor 120, memory 130, and display 140. Display 140 includes user interface 145. Server 150 includes processor 160 and memory 170. Memory 170 includes PredictEV tool 171, which includes adoption model 172, mobility model 174, and inference engine 176. While not specifically shown in FIG. 1, components of computing device 110 and server 150 may communicate via one or more data buses. The components of system 100 are only exemplary and other configurations of system 100 may be used.

In one implementation, computing device 110 may correspond to a tablet, laptop, desktop, smartphone, or other computing device. Computing device 110 may utilize PredictEV tool 171 to assist in predicting EV adoption and planning EVCS infrastructure. For example, in an implementation, computing device 110 may execute a browser to access PredictEV tool 171 via a website or web-based application provided by server 150 over network 180. In another implementation, computing device 110 may execute a local client application or software as a service (SaaS) to interface with PredictEV tool 171. PredictEV tool 171 may cause user interface 145 to be shown on display 140, allowing a user of computing device 110 to interactively select regions, traffic corridors, and points of interest for EV demand forecasting and EVCS infrastructure planning.

Processors 120 and 160 may be any type of general-purpose single or multi core processor, or a specialized processor such as application-specific integrated circuit (ASIC) or field programmable gate array (FPGA), and more than one processor 120 or 160 may also be present. Memory 130 and 170 may be any type of memory, such as a random access memory (RAM) or other dynamic storage device.

Databases 190A, 190B, and 190C may include region-specific statistical data regarding EV registrations, EVCS infrastructure, EV pricing and sales data, population demographics, traffic patterns, and other data that can be utilized as training data and/or input data for adoption model 172, mobility model 174, and inference engine 176. Databases 190A-190C may be provided by various third parties and may be updated on a periodic basis. While three databases are shown, any number of databases and data sources may be utilized.

### III. Estimating EV Adoption

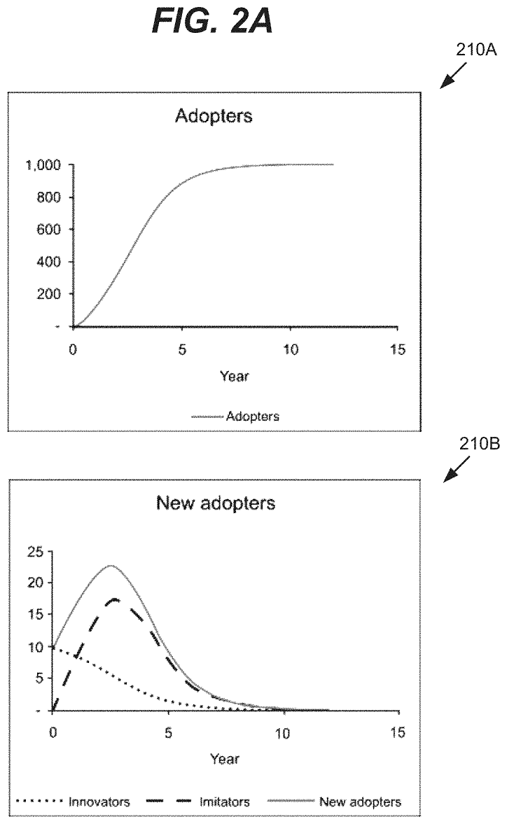

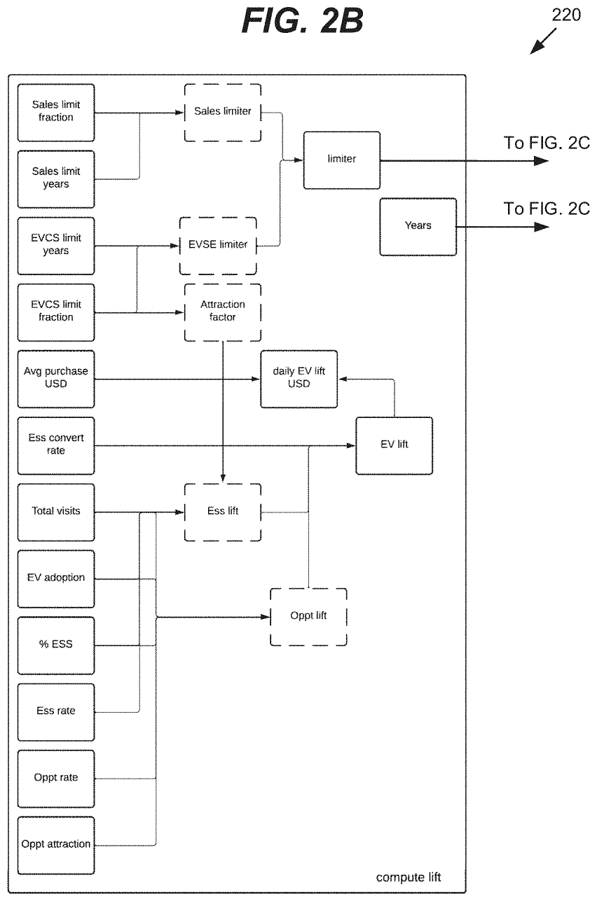

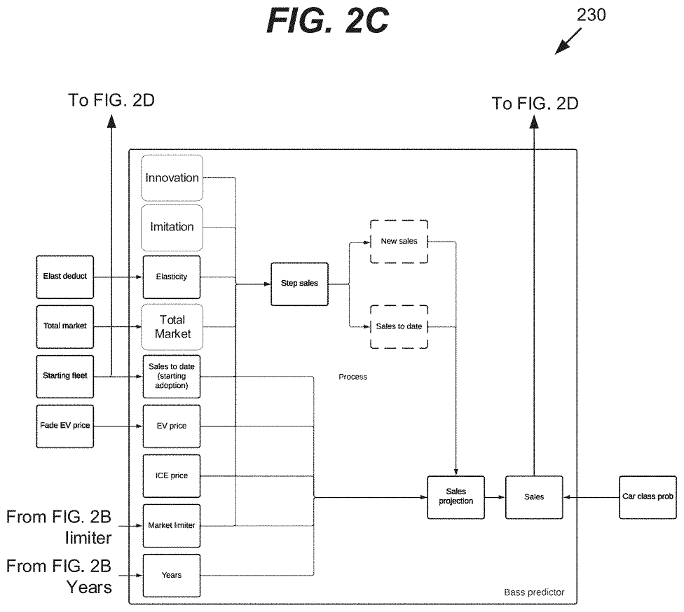

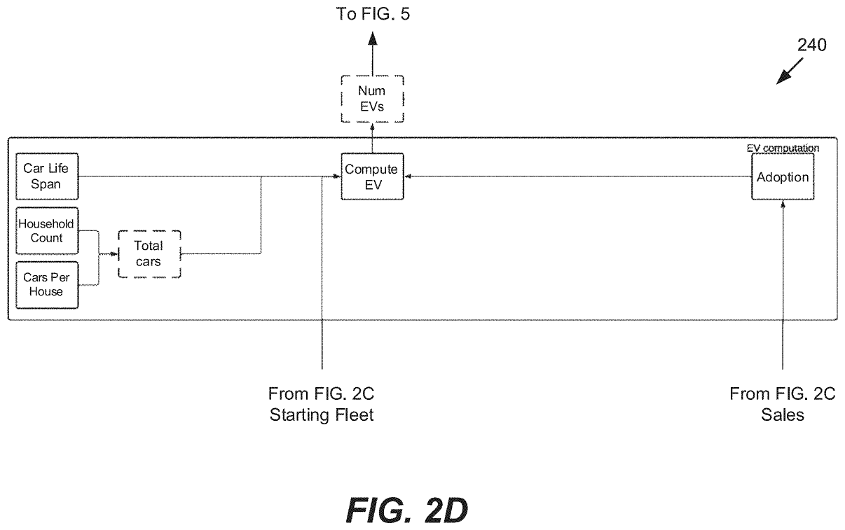

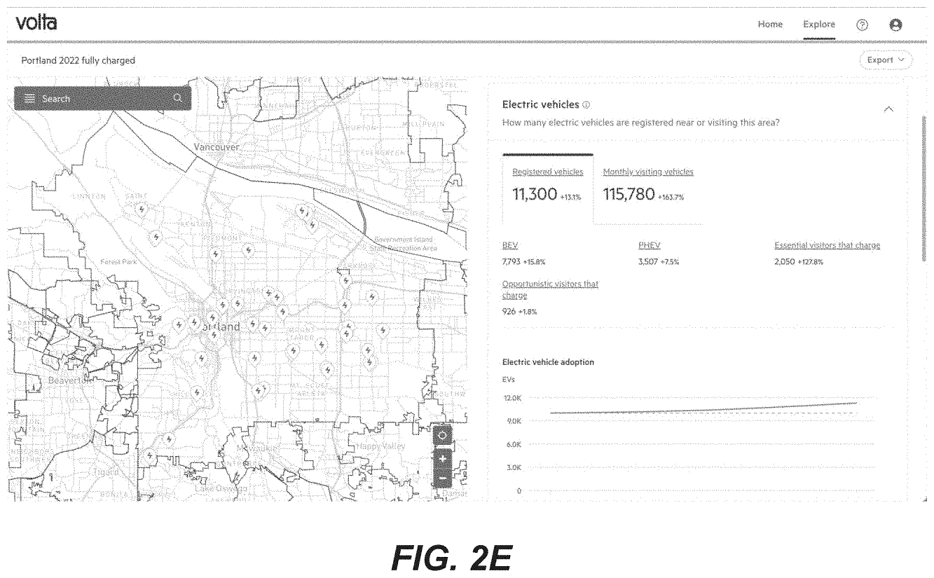

FIG. 2A is a diagram that depicts charts of adoption over time using a Generalized Bass diffusion model (“Bass model”). The Bass model is a framework for modeling the spread of new products through a population of consumers, which can be defined according to a specific region. While the Bass model is specifically illustrated in FIG. 2A, other statistical and analytical models may be used to model demand for a population within a region. Chart 210A depicts cumulative adoption of a product over time for a population, whereas chart 210B depicts new or additive adoption of the product over time, which is further divided into two coefficients: “innovators”, or early adopters, and “imitators”, or users that adopt the product once they observe others using the product.

The Bass model is generalized by its ability to account for various other factors besides the adoption behavior of innovators and imitators. In the context of EV adoption, these factors may include: relative cost difference compared to ICE vehicles, including government incentives such as rebates and credits, price elasticity or population sensitivity to the relative cost difference between ICE vehicles and EVs, EV driving range limits on a single charge in comparison to driver commutes and long-distance trips, available EVCS infrastructure at home, work, and at public places, and market size, including local availability of EVs for purchase. These factors may be derived from industry data, e.g. data available from databases 190A-190C, and integrated into a Bass model that is used by adoption model 172.

FIG. 2B is a block diagram 220 that depicts a computation of EV sale limits and POI sales lift for a region, according to an implementation. The left column of elements and the “Years” element may correspond to input values, which can be retrieved from databases 190A-190C. Besides the input values, dotted elements may correspond to intermediate value calculations, while solid elements other than the input values may correspond to finalized output values. The “compute lift” block may be considered as an input for the Bass model of FIG. 2C, wherein the “limiter” output value and “Years” input value are passed as inputs into a “Bass predictor” block in FIG. 2C, as indicated by the arrows in FIG. 2B. The specific elements shown in FIG. 2B are only exemplary and other elements may be included.

Before considering the contents of FIG. 2B, it may be helpful to describe a classification of EV drivers into two groups: Essential Drivers (ESS) and Opportunistic Drivers (OPP or OPPT). Essential Drivers have an immediate demand for charging and need to charge as quickly as possible, thus generally requiring DC fast charging speeds. Examples of Essential Drivers include drivers with limited home charging facilities (e.g. households with 120V chargers, or apartments lacking charging units or accessible charging units near safe parking), rideshare drivers that need to recharge to get back to servicing clients as quickly as possible, and long-distance drivers that need to refuel to continue with their trip as scheduled.

On the other hand, Opportunistic Drivers may have greater access to charging options in their work or home locations, and therefore OPP drivers see public charging stations as a convenient way to “top off” their EVs while occupied with other activities at a POI. In this regard, the speed of the charging station is less important for Opportunistic Drivers, and they may be more price sensitive to fuel charges compared to Essential Drivers. Examples of Opportunistic Drivers include drivers with high speed home chargers (e.g. 240V household chargers or large apartments with adequate charging facilities) or chargers at their work location. Opportunistic Drivers may be attracted to POIs that offer free or low-cost EV charging with cost effective but slower chargers such as L2 chargers. Since OPP drivers are focused on other activities at the POIs, dwell times at charging stations may be minimally affected. According to available data, OPP Drivers make up approximately 85% of the current EV driving public, but the ratio of Essential Drivers and Opportunistic Drivers may be adjusted by the user, or according to prevailing data trends.

The inputs in FIG. 2B may include existing EV sales data as well as existing visitation data for one or more POIs within a selected region for a population being analyzed for EV adoption, and the inputs may be aggregated by hours, days, or another granularity. For example, the “Sales limit fraction” and “Sales limit years” may define a fraction or percentage of the population that has purchased one or more EVs over a defined period. These inputs may reflect the past demand for EVs, which can be used to estimate current and future demand for EVs. For example, various region-specific factors such as garage or parking space, household EV charger capacity, electrical wiring capacity, electric generation costs, and relative costs compared to ICE vehicles can influence the number of EVs a household is able to purchase and maintain, which are reflected in the past sales data. Based on this information, a “Sales limiter” value can be determined that reflects the limitations of past EV sales for current and future EV sales.

Similarly, households may be less willing to purchase EVs unless adequate charging infrastructure is already in place to support EV charging requirements for work or long-distance travel. Accordingly, the quantity and quality of existing EVCS infrastructure that has developed over a defined period within a region can be reflected in the “EVCS limit fraction” and “EVCS limit years” in a manner similar to the “Sales limit fraction” and “Sales limit years” described above, resulting in a “EVCS limiter” value that reflects the limitations of prior charging infrastructure development on current and future EV sales. The combination of the “Sales limiter” and the “EVSE limiter” forms a general “limiter” that can be provided as an input to the Bass model in FIG. 2C, along with the “Years” or the period that the input data relates to.

A. Economic Lift for POI with EVCS

The remaining inputs in FIG. 2B may be used to determine the likelihood of a lift, or positive income effects from an EVCS at one or more POIs in the region being analyzed. For example, the presence of an EVCS may attract EV drivers that would not otherwise visit the POI, which may lead to additional revenue at businesses located at the POI. For example, the “EVCS limit years” and “EVCS limit fraction” may be used to determine an “Attraction factor” for ESS Drivers. If a given immediate vicinity around a POI has significant charging infrastructure already in place, then the attraction for visiting that POI specifically for charging may be low; conversely, if a given immediate vicinity around a POI has a small number of charging stations, then an EVCS at the POI may provide a significant attraction for ESS drivers.

The “Attraction factor”, along with “Total visits”, “EV adoption”, “% ESS” (percentage of ESS versus OPP drivers), and “ESS rate” (decision whether to charge) all contribute to determining “ESS lift”, or the total lift from ESS drivers. Similarly, “Total visits”, “EV adoption”, “% ESS” (the OPP portion), “OPPT rate” (decision whether to charge), and “OPPT attraction” all contribute to determining “OPPT lift”, or the total lift from OPP drivers.

By combining the “ESS lift” and the “OPPT lift” with the “ESS convert rate” (or a purchase conversion rate for ESS drivers at a POI) and “Avg purchase USD” (of purchases made at facilities at the POI, such as a convenience or grocery store), a “daily EV lift USD” can be determined for current and future conditions. The “Avg purchase USD” may be based on store type, customer demographics, and other actual or projected data. Accordingly, an analysis can be readily provided for optimizing or maximizing potential economic benefits from adding an EVCS to a POI.

B. Bass Model EV Sales Predictor

Once the “limiter” is determined in FIG. 2B, the “limiter” output along with the “Years” input may be provided as inputs to FIG. 2C, a block diagram 230 that depicts projection of future sales using a Bass model, according to an implementation. Outside of the “Bass predictor” block are various inputs, including the “limiter” and “Years” from FIG. 2B, “Elastic deduction” (change in elasticity, e.g. to test for different elasticity scenarios), “Total market” (total potential market for EVs), “Starting fleet” (current EV fleet), “Fade EV price” (reduction in EV price), and “Car class prob” (probability distribution of purchasing various car types, e.g. sedan, SUV, etc.). While the “Car class prob” is shown as solely a singular input into the “Bass predictor” block, other implementations may use a more granular approach to predict adoption of different classes of EVs. For example, tailored and class-specific prediction functions and blocks may be used in the Bass predictor block for sedans, trucks, SUVs, compacts, and other vehicle classes. Further, the “Car class prob” can be retrieved as static data from databases 190A-190C and/or dynamically generated based on predictive models using demographic data or other information.

Within the “Bass predictor” block, the left column are Bass model inputs, including the classical inputs of “Innovation”, “Imitation”, and “Total market”, as well as the EV specific factors such as “Elasticity”, “Sales to date (starting adoption)”, “EV price”, “ICE price”, “Market limiter” (from FIG. 2B), and “Years” (from FIG. 2B). Based on these inputs, the Bass model can apply “Step sales” to determine “New sales” and “Sales to date” for future steps or time periods. These can be combined to form a “Sales projection” for current and future time periods. Combining the “Sales projection” with the “Car class prob” outputs the “Sales”, or projected sales of various types of EVs now and into the future.

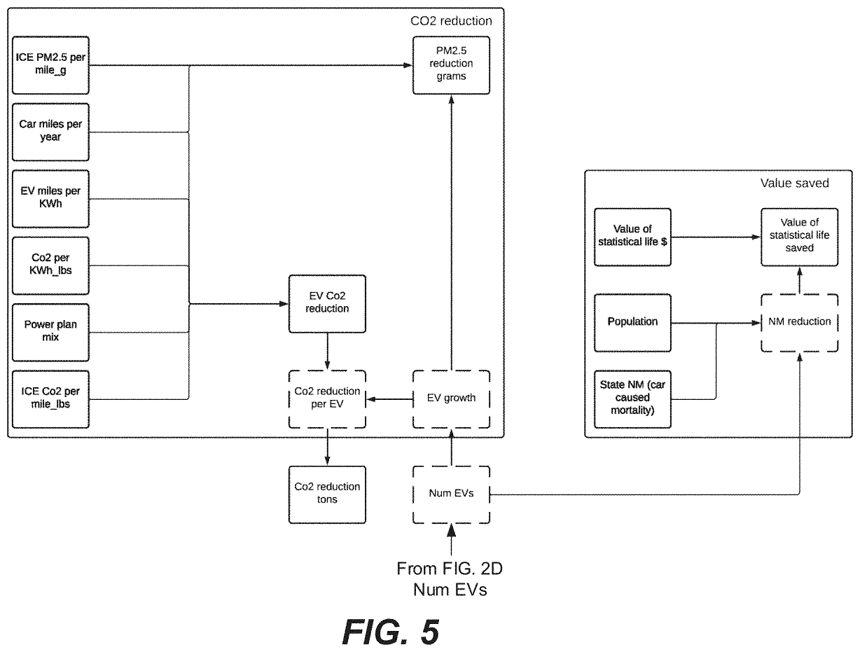

Once the “Sales” is determined in FIG. 2C, the “Sales” output and the “Starting fleet” input may be provided as inputs to FIG. 2D, a block diagram 240 that depicts estimation of EV adoption, according to an implementation. As shown in the “EV computation” block of FIG. 2C, the left column of inputs, or “Car life span”, “Household count”, and “Cars per House” are combined with the “Adoption” from the “Sales” of FIG. 2B to the “Compute EV” function, which calculates a “Number of EVs” at a current or future point in time. The “Household count” and “Cars per House” may be based on actual data retrieved from databases 190A-190C or estimated using predictive models. Based on the “Number of EVs”, a determination of societal and environmental impacts can also be determined, as discussed in conjunction with FIG. 5 below.

C. User Interface for EV Adoption

FIG. 2E is a diagram that depicts an example user interface for displaying current and estimated EV adoption, according to an implementation. FIG. 2E may correspond to user interface 145 of FIG. 1. As discussed above, the user may first select a region of interest, in this case the city of Portland. For the region, current EV adoption statistics are provided, including a total number of registered EVs as well as a division between full battery EVs (BEV) or plug-in hybrid electric vehicles (PHEV). The user may click on the alternative tab to switch to “Monthly visiting vehicles”, which includes vehicles that are visiting from outside of the region.

For the selected tab, public charging data is presented, including ESS drivers and OPP drivers that use public charging facilities. EV adoption over time also is provided in a graph. Each of the statistics may be coupled by a percentage change, which may represent a gain or loss compared to a point in time in the past, which may be configurable by the user, for example compared to a previous year. When available, actual data from databases 190A-190C may be utilized; otherwise, past data may be processed through the Bass model to generate an estimate.

Besides comparing against past dates, PredictEV tool 171 may also be configured to provide EV adoption predictions for future dates and times, which can be determined using the Bass model calculations as described above. For example, a user may specify to predict EV adoption 5 years into the future, allowing users to plan and prepare for future EVCS infrastructure.

### IV. Mobility Simulation for Predicting Commutes

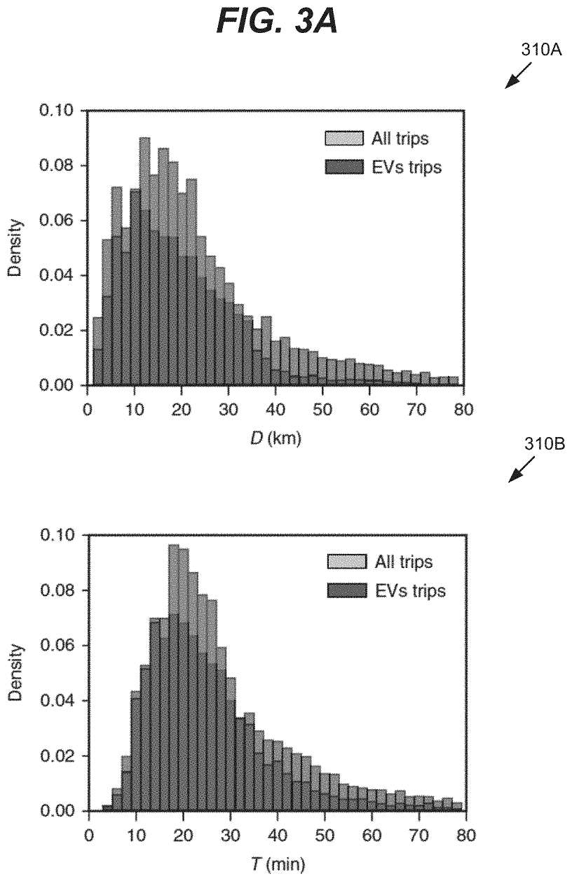

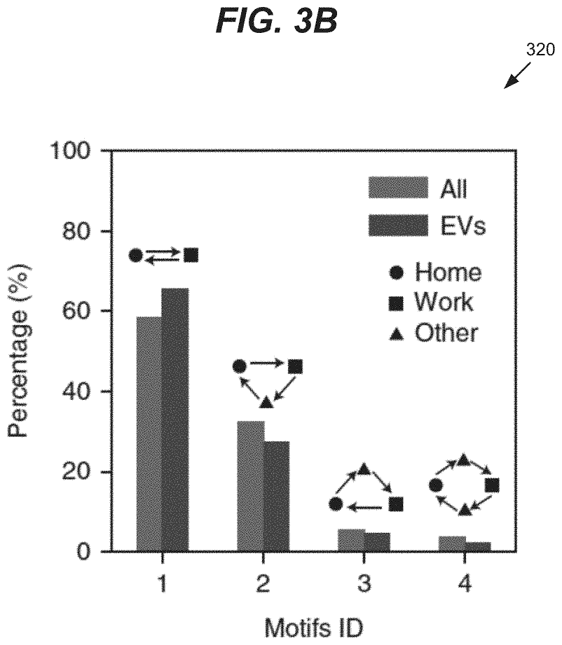

FIG. 3A is a diagram that depicts probability distributions 310A and 310B of distance (D) and commute times (T) prior to arrival at a POI for use in a mobility simulation or mobility model 174, according to an implementation. Once the number of EV drivers is determined for a region, as described above, a mobility simulation may be carried out to simulate driver behavior in the region currently and into the future. Based on the result of the simulation, EVCS infrastructure deployment can be planned to meet the estimated demand resulting from the mobility simulation. As an initial step in the mobility simulation, probability distributions of driver behavior prior to reaching an EVCS at a POI may be determined.

Probability distribution 310A indicates the distance travelled (D, in km) before a simulated driver reaches a POI. Probability distribution 310A may be statistically derived from existing trip data and driver demographic information available from databases 190A-190C, which may include data from streetlights, traffic signals, and government transportation agencies. As shown in FIG. 3A, the distribution is illustrated for EV drivers as well as all drivers. Shorter distances may indicate trips to the POI when leaving work, going to lunch break, or returning from work. Longer distances may indicate long distance trips or travel to distant workplaces.

Similarly, probability distribution 310B indicates a commuting travel time (T, in minutes) before a simulated driver reaches a POI. Probability distribution 310B may also be statistically derived using information available from databases 190A-190C. Since distance traveled and time driving are correlated, probability distributions 310A and 310B may appear similar, but variances may occur due to traffic, accidents, weather, and other factors that introduce commuting delays.

Another probability distribution may be used to estimate the range of a simulated driver's EV for determining how much each EV needs to charge when arriving at a POI. For example, one probability distribution may assign 20% of EVs with a range of 80 miles, 50% of EVs with a range of 125 miles, and 30% of EVs with a range of 250 miles. The distribution may be manually adjusted by the user or adjusted according to the known “Starting fleet” composition and future “Sales” composition of EVs, as shown in FIG. 2C.

EV drivers may be further categorized according to their residential unit type and therefore home charging access type. For example, based on census data, geographic information, and mapping data available from databases 190A-190C, EV drivers may be assigned to housing types, which have associated probability distributions for statistically available home chargers. In some implementations, predictive models may be used to supplement or substitute for actual home charging data retrieved from databases 190A-190C. For example, single family homes and small apartments (less than 10 units) may be assigned a first distribution with 15% no charger, 15% 120V charger, 40% 240V charger, and 30% L2 charger. Large apartments (10 or more units) may be assigned a second distribution with 70% no charger, 5% 120V charger, 5% 240V charger, and 20% L2 charger. Based on the type of home charger available, the home charging speed is known and a starting charge level for a simulated EV's battery can be estimated. For example, it may be assumed that most EV drivers will elect to charge overnight each day, or for approximately 12 hours. The above distributions are only example distributions and may be manually adjustable by the user or automatically adjusted according to available data from databases 190A-190C.

Similarly, EV drivers may be further categorized according to their workplace and therefore work charging access type. In some implementations, predictive models may be used to supplement or substitute for actual workplace charging data retrieved from databases 190A-190C. A probability distribution applicable to the working population generally may assign 85% to no charger, 5% to 240V charger, and 10% to L2 charger. It may be assumed that workers charge 3 hours before lunch break and 3 hours after lunch break. Accordingly, by combining the work charging access type with the initial charge level from the home charging access type and an estimated battery drain from a work commute, a battery charge level can be estimated for EV drivers on lunch break or returning from work.

Once the battery level, range, and previous driving distance and/or driving time are known by using the above described probability distributions, then the current charge level and maximum charge for a simulated EV arriving at a POI can be determined. A target charge level for refueling can be determined based on the driver classification. For example, ESS drivers may be satisfied by charging to near full capacity, or approximately 95% of the maximum charge, to minimize refueling stops. On the other hand, OPP drivers may be satisfied with charging to 80% of the maximum charge, or if pressed for time, to briefly charge to add an additional 20 miles of range.

When a selection of chargers with different charge speeds is available at the EVCS of the POI, the EV driver may be projected to select the most cost-effective charger to meet the target charge level within a dwell time expected for the driver and/or the POI. For example, an EVCS may provide a mix of chargers with L2 7 kW, DCFast 50 kW, and DCFast 150 kW charging speeds and associated ascending price tiers. If a simulated driver is expected to dwell at the POI for 20 minutes and the target charge level can be reached with either DCFast 50 kW or 150 kW within 20 minutes, then the driver may be projected to prefer the lower cost DCFast 50 kW charger, subject to availability. In some implementations, if all DCFast 50 kW chargers are occupied due to peak commute activity, the driver may fallback to using an available DCFast 150 kW charger.

While selecting the most cost-effective charger to meet a target charge level for an expected dwell time may be a good baseline to model driver charging behavior, ESS drivers may be more likely than OPP drivers to select a faster charging tier regardless of cost, as ESS drivers may prioritize shorter charging time to quickly return to their task at hand (e.g. continuing a long distance trip or servicing rideshare clients). Further, if the dwell time is expected to be short, such as 5 minutes or less, then the driver may not have time to charge and may simply leave a POI without charging, even if an EVCS is available. These and other factors may be used to modify the above-described baseline charging behavior of EV drivers.

FIG. 3B is a diagram that depicts chart 320 for categorizing commuters into defined mobility motifs for use in a mobility simulation, according to an implementation. As shown in chart 320, EV drivers are statistically distributed into four motifs for a simulated workday: going from home to work and straight back home (Motif 1), going from home to work to other (a POI stop) and back home (Motif 2), going from home to other to work and back home (Motif 3), and going from home to other to work to other and back home (Motif 4). For example, Motif 1 may correspond to going straight to work and back home without any stops to POIs, Motif 2 may correspond to taking a lunch break or visiting another POI after work, Motif 3 may correspond to getting breakfast or visiting another POI before work, and Motif 4 may correspond to making stops to POIs both before and after work. Based on the Motif, a driver's inclination to charge their EV at a public charging station (i.e. while at the “other” POI) may change. Further, the driver's willingness to tolerate longer charge times may also be affected by the Motif. For example, an EV driver may be less willing to charge for an extended time before work or during a lunch break, whereas time constraints may be less of a concern when charging after work.

V. Inference Engine with Visitation Model for Determining Optimal EVCS Mix

Based on the factors described above for mobility model 174, inference engine 176 may determine whether a simulated EV driver makes a stop at a POI, and if so, how long the EV driver dwells at the POI and whether the EV driver chooses to charge their EV. The decision whether to charge or not may depend on whether the EV driver is an ESS driver or an OPP driver and region-specific EV driver behaviors. Assuming the EV driver does choose to charge, a determination can be inferred with regards to type, speed, and cost of a charger the EV driver is likely to choose to reach a target charge level within or close to the estimated dwell time.

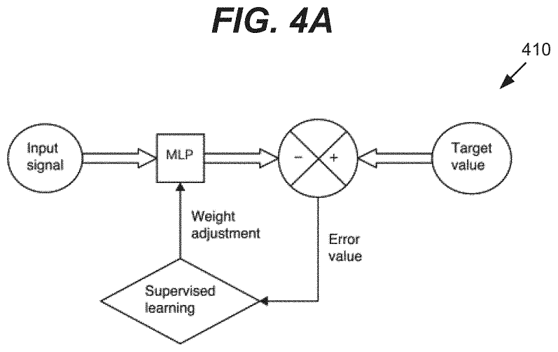

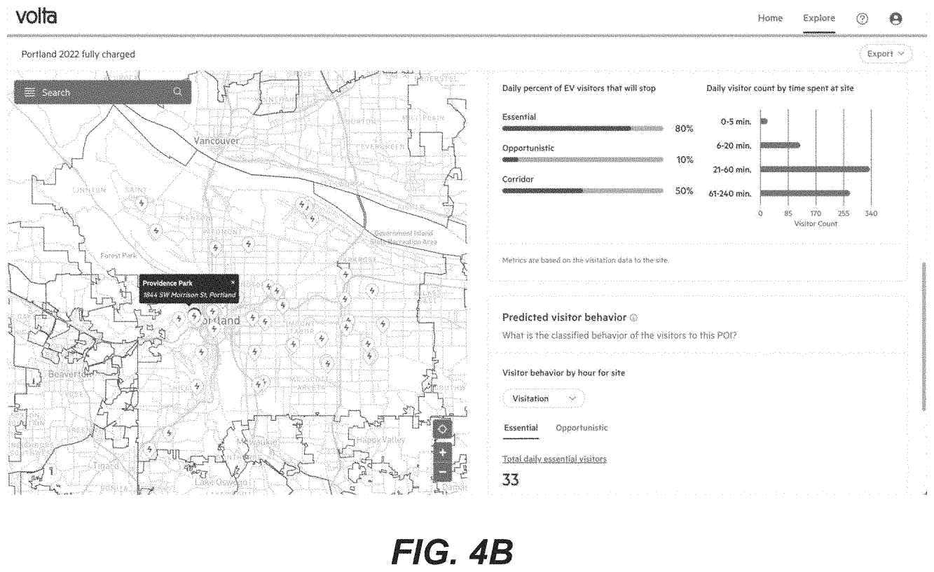

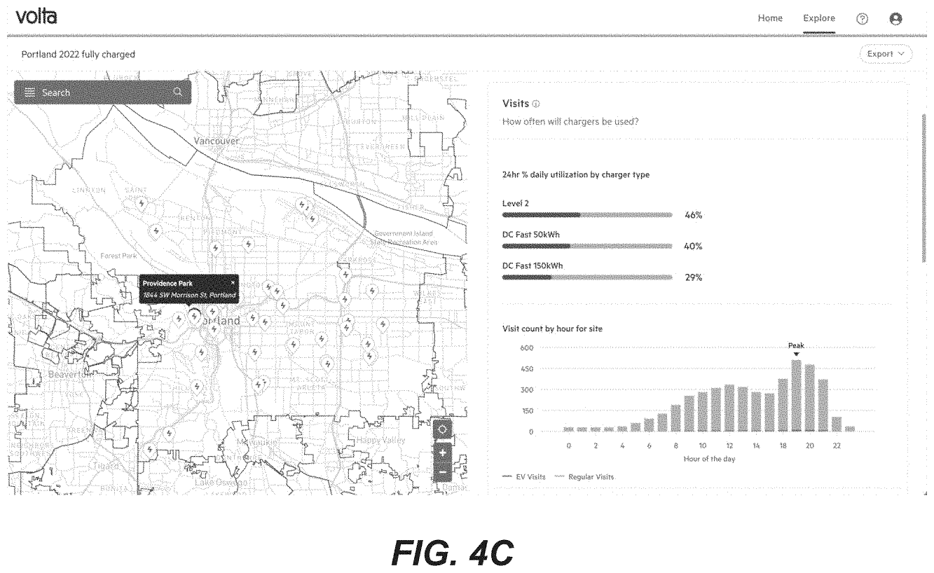

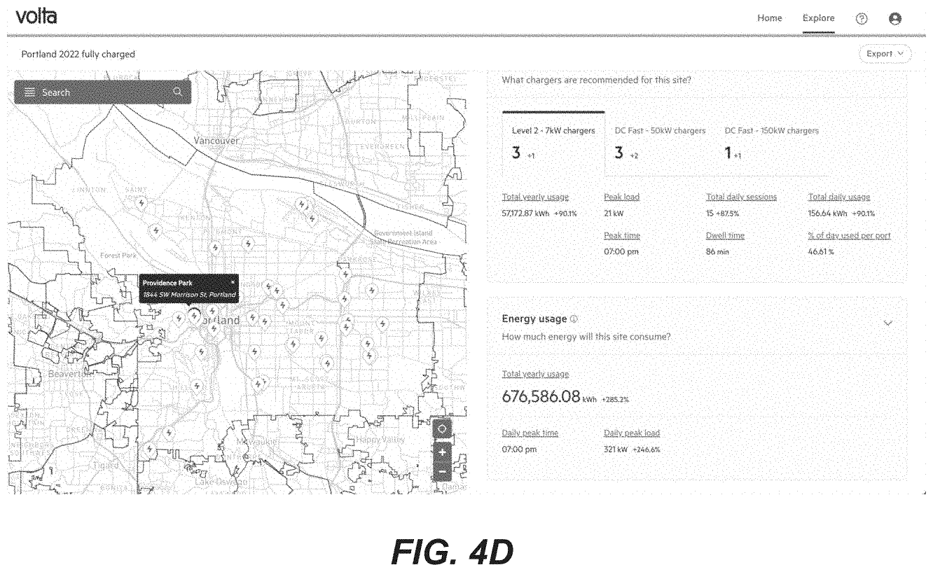

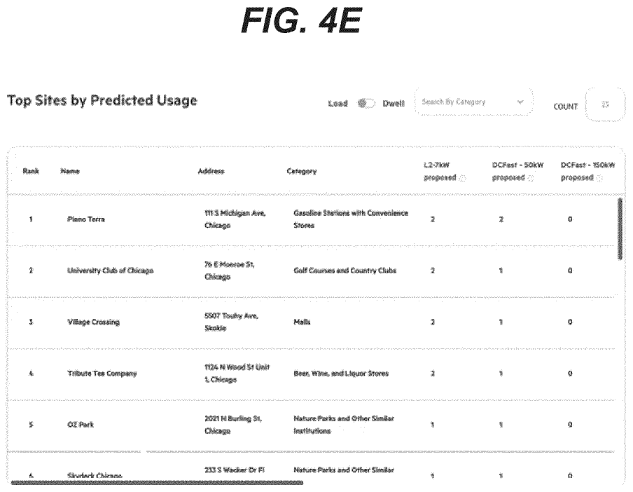

Further, inference engine 176 may also integrate visitation modeling, or predicting visitors at a selected POI over time, such as a monthly average. One approach to providing inference engine 176 is shown in FIG. 4A, a diagram that depicts an example two-layer multilayer perceptron (MLP) neural network 410 for predicting visitation to a POI, according to an implementation.

The input signal and target value may correspond to data retrieved from databases 190A-190C, which may include POI-reported guest data and self-reported visitation data from guests of a POI. This data may include POI identifying information, such as name, brand, and business category, visitation data including hourly, median, and mean dwell time and visitor counts (derivable from geospatial data), and regional data including average distance to visitor homes, population within local regional blocks of various sizes, and data from trackable devices (e.g. smartphones) within local regional blocks of various sizes.

As shown in FIG. 4A, the input signal is provided into a feedback loop. First, the input signal is processed by a 2-layer multilayer perceptron (MLP) neural network, and the error value or loss function (mean squared error) between the predicted visitation (output of MLP) and actual visitation (target value) is minimized as part of a supervised learning process that continually adjusts the weights of the parameters in complex equations within the 2-layer MLP neural network. After training, the error margin can be reduced such that the predictions of the MLP neural network can be used as viable predictions for future visitation at the POI. While a 2-layer MLP neural network is used as an example, other neural networks and machine learning techniques may also be utilized to predict future visitation.

By combining the above-described EV adoption estimation, mobility simulation, and POI visitation model, inference engine 176 can forecast charging demand for a specific POI into the future, which in turn informs recommendations for EVCS deployment including a recommended mix of charging stations to meet the projected charging demand. This can then be presented to a user in various user interfaces.

In some implementations, a user may request recommendations for EVCS deployment within a region, and based on analysis of POIs within the region, an ordered ranking of deployment sites may be presented to the user, wherein higher ranked deployment sites satisfy the EV charging needs of the region more effectively compared to lower ranked sites. An example is shown in FIG. 4E, a diagram that depicts an example user interface for displaying a ranking of POIs for EVCS deployment, according to an implementation. From the ranking, the user may select a POI for further analysis.

FIG. 4B is a diagram that depicts an example user interface for displaying current and estimated visitation to a POI, according to an implementation. As shown in FIG. 4B, the user can select a specific POI, or “Providence Park”. Current visitation statistics are provided to the user, including a breakdown of ESS, OPP, and traffic corridor (“corridor”) EV drivers. Corridor EV drivers drive along established traffic corridors, such as interstate highways, and may be considered as a subset of ESS drivers, as their primary goal for visiting a POI may be refueling for long distance trips. To address the needs of corridor EV drivers, POIs may be ranked higher when proximate to exits along traffic corridors, such as within 5 miles of an exit. A breakdown of daily visitors and mean dwell times is also provided, as well as predicted visitor behavior for EV drivers, or specifically how many of each EV driver class will choose to utilize an EVCS at the POI. The predictions may be adjusted to correspond to a current or future time.

FIG. 4C is a diagram that depicts an example user interface for displaying charger type usage and hourly visitation to a POI, according to an implementation. As shown in FIG. 4C, a breakdown of each charger type is provided, along with a projected hourly visitation and a peak hour for which demand may be targeted. Queuing theory may be utilized to determine how long queue waits will be for the worst-case scenario at the POI, or the peak hour. When average or mean dwell times are longer, a larger quantity of chargers may be necessary to reduce queue sizes. In some implementations, minimizing the queue waits may be one goal for EVCS deployment.

FIG. 4D is a diagram that depicts an example user interface for displaying EVCS recommendations and projected energy usage for a POI, according to an implementation. As shown in FIG. 4D, a breakdown of available EV chargers and types are provided, along with a recommendation of how many chargers to add for each type to satisfy current or future projected demand. Further, for a selected charger type, an aggregate annual usage is provided, along with peak load, peak time, total daily charging sessions, average or mean dwell time, and total daily usage. Daily charger utilization rates (% in use) are also provided and meeting a threshold usage level may be one criterion for EVCS deployment optimization. In the case where existing EVCS infrastructure does not exist at the POI, a breakdown may be provided for new site infrastructure. Further, while the statistics are provided in aggregate and summarized, the user may have the option to view a more detailed hourly breakdown for each of the metrics shown in FIG. 4D.

Energy usage is also provided, which may be relevant for utilities and municipalities seeking to balance power draw for power grid considerations. While the energy usage shown in FIG. 4D is aggregated for all chargers on an annualized basis and max power draw for daily peak hour usage, the user may also elect to show a more granularized representation, such as power draw or energy used for each type of charger or all chargers on an hourly basis.

### VI. Measuring Impact Metrics

FIG. 5 is a block diagram that depicts estimated harm reduction from EV adoption, according to an implementation. As discussed above, the adoption of EVs may provide societal and environmental benefits by phasing out the usage of ICE vehicles. Thus, by using the number of EVs determined from FIG. 2D, a benefit or harm reduction can be quantified using the example model shown in FIG. 5. Maximizing these benefits or harm reductions can be used as one optimization factor for the mobility simulation described above.

For example, one harm reduction is the reduction of harmful emissions. Based on various factors such as the particulate matter (PM2.5) emitted by ICE vehicles, the externalities caused by power plan mix (e.g. coal power plants) for EV charging, and the extent that EV vehicle usage is substituting for ICE vehicle usage, a CO2 reduction in tons and a PM 2.5 reduction in grams can be estimated, and corresponding improvements in health outcomes and air quality can be determined. The harm reductions can also be determined with a high level of granularity, e.g. by identifying harm reductions according to specific vehicle classes or other criteria, or by identifying harm reductions using geospatial areas. For example, a heatmap may be provided to predict higher PM2.5 reductions around high traffic corridors and roads. Corresponding health outcome improvements can be projected for populations within heatmap regions identified with reduced PM2.5 emissions.

In another example, one harm reduction is the reduction of human mortality resulting from the reduction of harmful emissions, noise pollution, engine accidents, and other factors associated with ICE vehicles. These reductions can be quantified in monetary terms, for example by reduction in healthcare costs, higher worker productivity, economic activity from higher employment levels, and other factors. Maximizing these benefits or harm reductions can be used as another optimization factor for the mobility simulation described above. For example, a user interface may be provided to enable a user to select a set of one or more optimization factors for generating needs or demands of a population within a selected region.

### VII. Implementation Processes

A. Providing EVCS Deployment Recommendations

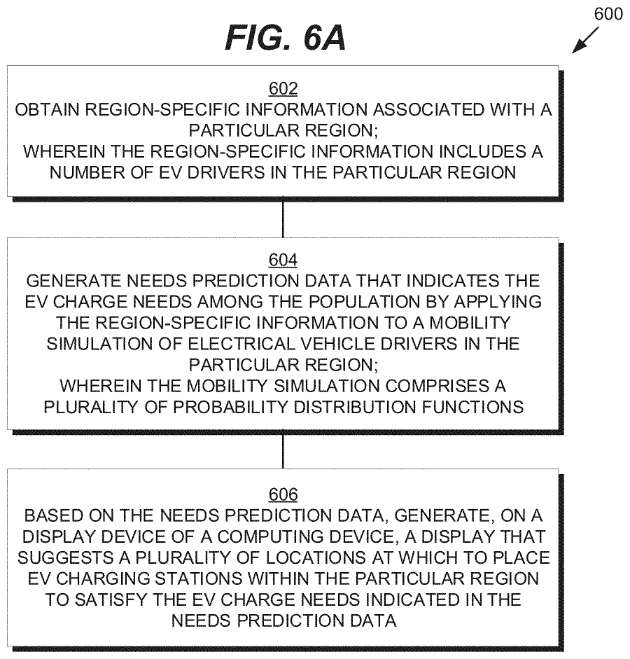

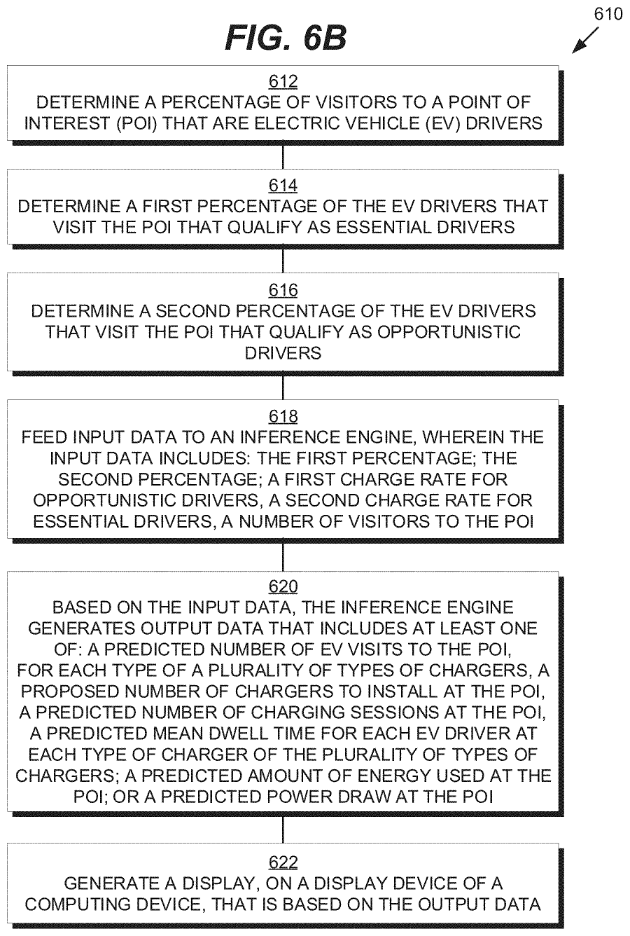

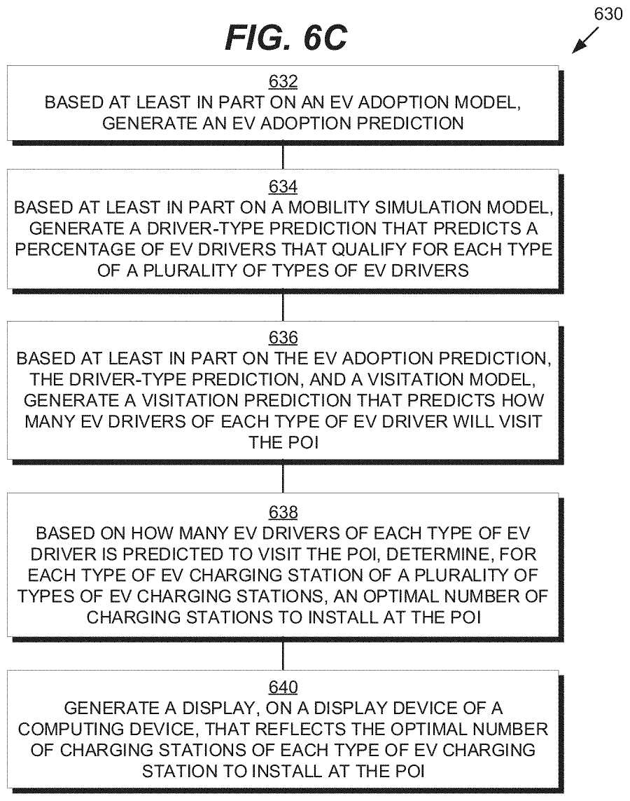

FIG. 6A is a flow diagram 600 that depicts an approach for providing electric vehicle charging station (EVCS) infrastructure deployment recommendations by estimating EV charge needs among a population in a region.

In block 602, processor 160 obtains region-specific information associated with a particular region, wherein the region-specific information includes a number of EV drivers in the particular region. For example, processor 160 may execute PredictEV tool 171, which in turn causes user interface 145 to be displayed on display 140. A user of computing device 110 may select a region (e.g. city, county, etc.) as described above. Based on the selected region, processor 160 may retrieve the associated region-specific information from databases 190A-190C.

In block 604, processor 160 generates needs prediction data that indicates the EV charge needs among the population by applying the region-specific information to a mobility simulation of electrical vehicle drivers in the particular region, wherein the simulation comprises a plurality of probability distribution functions. For example, processor 160 may apply the retrieved information to mobility model 174, which may implement the mobility simulation as described above. The probability distribution functions may include commute distance before arriving at a POI, commute time before arriving at a POI, and classification into a mobility motif.

In block 606, processor 160 generates, based on the needs prediction data, user interface 145 to be output on display 140 that suggests a plurality of locations at which to place EV charging stations within the particular region to satisfy the EV charge needs indicated in the needs prediction data. For example, a user interface similar to the user interface shown in FIG. 4E may be provided, wherein a ranking of POIs are provided for EVCS deployment.

B. Providing Estimated EVCS Demand at a POI

FIG. 6B is a flow diagram 610 that depicts an approach for providing estimated EVCS demand at a POI.

In block 612, processor 160 determines a first percentage of EV drivers to a point of interest (POI) that are electric vehicle (EV) drivers. For example, adoption model 172 may be used to determine a percentage of EV drivers within a region, which may be based on region specific data from databases 190A-190C, as illustrated by the input “EV adoption” in FIG. 2A.

In block 614, processor 160 determines a first percentage of the EV drivers that visit the POI that qualify as essential drivers. For example, adoption model 172 may be used to determine a percentage of ESS drivers within a region, which may be based on region specific data from databases 190A-190C, as illustrated by the input “% ESS” in FIG. 2A. In some implementations, the ESS driver percentage may be set to approximately 15%.

In block 616, processor 160 determines a second percentage of the EV drivers that visit the POI that qualify as opportunistic drivers. For example, adoption model 172 may be used to determine a percentage of OPP drivers within a region, which may be based on region specific data from databases 190A-190C, as illustrated by the input “% ESS” in FIG. 2A (since the % OPP is derivable from the % ESS). In some implementations, the OPP driver percentage may be set to approximately 85%.

In block 618, processor 160 feeds input data to an inference engine, wherein the input data includes the first percentage from block 614, the second percentage from block 616, a first charge rate for OPP drivers, a second charge rate for ESS drivers, and a number of visitors to the POI. For example, referring to FIG. 2A, the first charge rate for OPP drivers may correspond to “Oppt rate”, the second charge rate for ESS drivers may correspond to “Ess rate”, and the number of visitors to the POI may correspond to “Total visits”. As shown in FIG. 2A, the inputs are fed into a Bass model or the Bass predictor of FIG. 2C, which may form a part of inference engine 176.

In block 620, processor 160, generates, based on the input data, output data using inference engine 176 that includes at least one of: a predicted number of EV visits to the POI, for each type of a plurality of types of chargers, a proposed number of chargers to install at the POI, a predicted number of charging sessions at the POI, a predicted mean dwell time for each EV driver at each type of charger of the plurality of types of chargers, a predicted amount of energy used at the POI, or a predicted power draw at the POI.

In block 622, processor 160 generates user interface 145, for outputting on display 140, that is based on the output data of block 620. For example, user interface 145 may appear similar to the user interfaces shown in FIGS. 4B, 4C, and 4D.

C. Providing Estimated Optimal EVCS Mix at POIs

FIG. 6C is a flow diagram 630 that depicts an approach for providing an estimated optimal number and mixture of types of EVCS at one or more POIs.

In block 632, processor 160 generates, based at least in part on EV adoption model 172, an EV adoption prediction. For example, as discussed above in section III, adoption model 172 may be used with data from databases 190A-190C to predict EV adoption for a desired time in the future.

In block 634, processor 160 generates, based at least in part on mobility model 174, a driver-type prediction that predicts a percentage of EV drivers that qualify for each type of a plurality of types of EV drivers. As discussed above, this may include ESS drivers, OPP drivers, and corridor drivers.

In block 636, processor 160 generates, based at least in part on the EV adoption prediction, the driver-type prediction, and a visitation model, a visitation prediction that predicts how many EV drivers of each type of EV driver will visit the POI. As discussed above, the visitation model may be used with inference engine 176.

In block 638, processor 160 determines, based on how many EV drivers of each type of EV driver is predicted to visit the POI, for each type of EV charging station of a plurality of types of EV charging stations, an optimal number of charging stations to install at the POI.

In block 640, processor 160 generates user interface 145 for outputting to display 140, user interface 145 reflecting the optimal number of charging stations to install at the POI from block 638. For example, user interface 145 may appear similar to the user interface shown in FIG. 4D.

### VIII. Hardware Overview

According to one implementation, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques, or may include digital electronic devices such as at least one application-specific integrated circuit (ASIC) or field programmable gate array (FPGA) that is persistently programmed to perform the techniques, or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

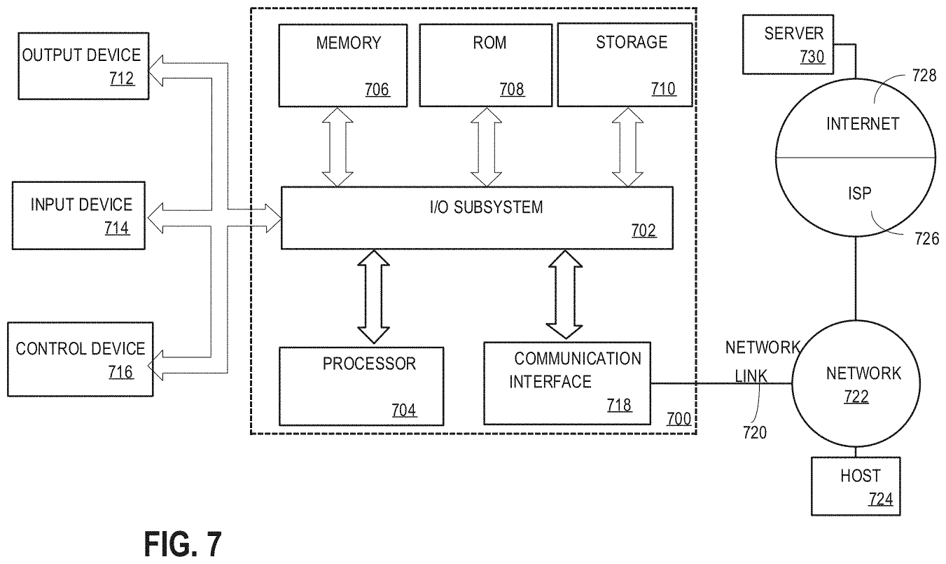

FIG. 7 is a block diagram that illustrates an example computer system with which an implementation may be implemented. In the example of FIG. 7, a computer system 700 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 700 includes an input/output (I/O) subsystem 702 which may include a bus and/or other communication mechanism(s) for communicating information and/or instructions between the components of the computer system 700 over electronic signal paths. The I/O subsystem 702 may include an I/O controller, a memory controller and at least one I/O port. The electronic signal paths are represented schematically in the drawings, for example as lines, unidirectional arrows, or bidirectional arrows.

At least one hardware processor 704 is coupled to I/O subsystem 702 for processing information and instructions. Hardware processor 704 may include, for example, a general-purpose microprocessor or microcontroller and/or a special-purpose microprocessor such as an embedded system or a graphics processing unit (GPU) or a digital signal processor or ARM processor. Processor 704 may comprise an integrated arithmetic logic unit (ALU) or may be coupled to a separate ALU.

Computer system 700 includes one or more units of memory 706, such as a main memory, which is coupled to I/O subsystem 702 for electronically digitally storing data and instructions to be executed by processor 704. Memory 706 may include volatile memory such as various forms of random-access memory (RAM) or other dynamic storage device. Memory 706 also may be used for storing temporary variables or other intermediate information during execution of instructions to be executed by processor 704. Such instructions, when stored in non-transitory computer-readable storage media accessible to processor 704, can render computer system 700 into a special-purpose machine that is customized to perform the operations specified in the instructions.

Computer system 700 further includes non-volatile memory such as read only memory (ROM) 708 or other static storage device coupled to I/O subsystem 702 for storing information and instructions for processor 704. The ROM 708 may include various forms of programmable ROM (PROM) such as erasable PROM (EPROM) or electrically erasable PROM (EEPROM). A unit of persistent storage 710 may include various forms of non-volatile RAM (NVRAM), such as FLASH memory, or solid-state storage, magnetic disk or optical disk such as CD-ROM or DVD-ROM, and may be coupled to I/O subsystem 702 for storing information and instructions. Storage 710 is an example of a non-transitory computer-readable medium that may be used to store instructions and data which when executed by the processor 704 cause performing computer-implemented methods to execute the techniques herein.

The instructions in memory 706, ROM 708 or storage 710 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 700 may be coupled via I/O subsystem 702 to at least one output device 712. In one implementation, output device 712 is a digital computer display. Examples of a display that may be used in various implementations include a touch screen display or a light-emitting diode (LED) display or a liquid crystal display (LCD) or an e-paper display. Computer system 700 may include other type(s) of output devices 712, alternatively or in addition to a display device. Examples of other output devices 712 include printers, ticket printers, plotters, projectors, sound cards or video cards, speakers, buzzers or piezoelectric devices or other audible devices, lamps or LED or LCD indicators, haptic devices, actuators or servos.

At least one input device 714 is coupled to I/O subsystem 702 for communicating signals, data, command selections or gestures to processor 704. Examples of input devices 714 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 716, which may perform cursor control or other automated control functions such as navigation in a graphical interface on a display screen, alternatively or in addition to input functions. Control device 716 may be a touchpad, a mouse, a trackball, or cursor direction keys for communicating direction information and command selections to processor 704 and for controlling cursor movement on display 712. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 714 may include a combination of multiple different input devices, such as a video camera and a depth sensor.

In another implementation, computer system 700 may comprise an internet of things (IoT) device in which one or more of the output device 712, input device 714, and control device 716 are omitted. Or, in such an implementation, the input device 714 may comprise one or more cameras, motion detectors, thermometers, microphones, seismic detectors, other sensors or detectors, measurement devices or encoders and the output device 712 may comprise a special-purpose display such as a single-line LED or LCD display, one or more indicators, a display panel, a meter, a valve, a solenoid, an actuator or a servo.

When computer system 700 is a mobile computing device, input device 714 may comprise a global positioning system (GPS) receiver coupled to a GPS module that is capable of triangulating to a plurality of GPS satellites, determining and generating geo-location or position data such as latitude-longitude values for a geophysical location of the computer system 700. Output device 712 may include hardware, software, firmware and interfaces for generating position reporting packets, notifications, pulse or heartbeat signals, or other recurring data transmissions that specify a position of the computer system 700, alone or in combination with other application-specific data, directed toward host 724 or server 730.

Computer system 700 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one implementation, the techniques herein are performed by computer system 700 in response to processor 704 executing at least one sequence of at least one instruction contained in main memory 706. Such instructions may be read into main memory 706 from another storage medium, such as storage 710. Execution of the sequences of instructions contained in main memory 706 causes processor 704 to perform the process steps described herein. In alternative implementations, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 710. Volatile media includes dynamic memory, such as memory 706. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 702. Transmission media can also take the form of acoustic or light waves, such as those generated during radio-wave and infra-red data communications.

Various forms of media may be involved in carrying at least one sequence of at least one instruction to processor 704 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 700 can receive the data on the communication link and convert the data to a format that can be read by computer system 700. For instance, a receiver such as a radio frequency antenna or an infrared detector can receive the data carried in a wireless or optical signal and appropriate circuitry can provide the data to I/O subsystem 702 such as place the data on a bus. I/O subsystem 702 carries the data to memory 706, from which processor 704 retrieves and executes the instructions. The instructions received by memory 706 may optionally be stored on storage 710 either before or after execution by processor 704.

Computer system 700 also includes a communication interface 718 coupled to bus 702. Communication interface 718 provides a two-way data communication coupling to network link(s) 720 that are directly or indirectly connected to at least one communication networks, such as a network 722 or a public or private cloud on the Internet. For example, communication interface 718 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 722 broadly represents a local area network (LAN), wide-area network (WAN), campus network, internetwork or any combination thereof. Communication interface 718 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 718 sends and receives electrical, electromagnetic or optical signals over signal paths that carry digital data streams representing various types of information.

Network link 720 typically provides electrical, electromagnetic, or optical data communication directly or through at least one network to other data devices, using, for example, satellite, cellular, Wi-Fi, or BLUETOOTH technology. For example, network link 720 may provide a connection through a network 722 to a host computer 724.

Furthermore, network link 720 may provide a connection through network 722 or to other computing devices via internetworking devices and/or computers that are operated by an Internet Service Provider (ISP) 726. ISP 726 provides data communication services through a world-wide packet data communication network represented as internet 728. A server computer 730 may be coupled to internet 728. Server 730 broadly represents any computer, data center, virtual machine or virtual computing instance with or without a hypervisor, or computer executing a containerized program system such as DOCKER or KUBERNETES. Server 730 may represent an electronic digital service that is implemented using more than one computer or instance and that is accessed and used by transmitting web services requests, uniform resource locator (URL) strings with parameters in HTTP payloads, API calls, app services calls, or other service calls. Computer system 700 and server 730 may form elements of a distributed computing system that includes other computers, a processing cluster, server farm or other organization of computers that cooperate to perform tasks or execute applications or services. Server 730 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 730 may comprise a web application server that hosts a presentation layer, application layer and data storage layer such as a relational database system using structured query language (SQL) or no SQL, an object store, a graph database, a flat file system or other data storage.

Computer system 700 can send messages and receive data and instructions, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage 710, or other non-volatile storage for later execution.

The execution of instructions as described in this section may implement a process in the form of an instance of a computer program that is being executed, and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 704. While each processor 704 or core of the processor executes a single task at a time, computer system 700 may be programmed to implement multitasking to allow each processor to switch between tasks that are being executed without having to wait for each task to finish. In an implementation, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an implementation, for security and reliability, an operating system may prevent direct communication between independent processes, providing strictly mediated and controlled inter-process communication functionality.

In the foregoing specification, implementations of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

1. A method for estimating electric vehicle (EV) charge needs among a population in a particular region, comprising:
obtaining region-specific information associated with the particular region;
wherein the region-specific information includes a number of EV drivers in the particular region;
generating needs prediction data that estimates the EV charge needs among the population by applying the region-specific information to a mobility simulation of electrical vehicle drivers in the particular region;
wherein the mobility simulation comprises a plurality of probability distribution functions;
based on the needs prediction data, generating, on a display device of a computing device, a display that suggests a plurality of locations at which to place EV charging stations within the particular region to satisfy the estimated EV charge needs indicated in the needs prediction data;
wherein the method is performed by one or more computing devices.

2. The method of claim 1 further comprising determining:
a first percentage of EV drivers in the particular region that qualify as essential drivers; and
a second percentage of EV drivers in the particular region that qualify as opportunistic drivers; and
wherein the needs prediction data is based, at least in part, on the first percentage and the second percentage.

3. The method of claim 2 wherein:
the needs prediction data includes information about:
a number of charging stations needed in the particular region;
a location of one or more charging stations needed in the particular region; and
a type of one or more charging stations needed in the particular region.

4. The method of claim 3 wherein the type of each charging station needed in the particular region is determined based, at least in part, on the first percentage and the second percentage.

5. The method of claim 2 wherein the first percentage and the second percentage are determined based, at least in part, on:
distributions of average distances EV drivers travel in the particular region;
ranges of EVs that are being driven in the particular region;
access to charging stations in the particular region;
charging speeds of charging stations in the particular region; and
duration of charging events in the particular region.

6. The method of claim 1 wherein:
the prediction is for a particular time in the future; and
the method further comprises predicting the number of EV drivers that will be in the particular region at the particular time based on a current number of EV users in the particular region and an EV adoption model.

7. The method of claim 6 wherein the EV adoption model takes into account at least:
relative cost of owning EVs versus internal combustion engine (ICE) vehicles;
sensitivity of drivers in the particular region to cost differences between EVs and ICE vehicles; and
charging infrastructure available in the particular region.

8. The method of claim 1 wherein:
the region-specific information includes home charging access information and work charging access information; and
the mobility simulation generates the needs prediction data based, at least in part, on the home charging access information and work charging access information.

9. The method of claim 1 wherein:
the region-specific information includes charging speeds of one or more EV charging stations within the particular region; and
the mobility simulation generates the needs prediction data based, at least in part, on charging speeds of EV charging stations within the particular region.

10. The method of claim 1 further comprising:
displaying user interface controls for selecting a set of one or more optimization factors from a plurality of optimization factors supported by the mobility simulation;
receiving user input that selects a particular set of one or more optimization factors;
wherein the mobility simulation generates the needs prediction data based on the particular set of one or more optimization factors.

11. The method of claim 10 wherein the plurality of optimization factors include:
satisfying demand for EV charging;
reducing demand on grid that results from EV charging; and
maximizing revenue lift.

12. One or more computing devices configured to:
obtain region-specific information associated with the particular region;
wherein the region-specific information includes a number of EV drivers in the particular region;
generate needs prediction data that indicates the estimated EV charge needs among the population by applying the region-specific information to a mobility simulation of electrical vehicle drivers in the particular region;
wherein the mobility simulation comprises a plurality of probability distribution functions;
based on the needs prediction data, generate, on a display device of a computing device, a display that suggests a plurality of locations at which to place EV charging stations within the particular region to satisfy the estimated EV charge needs indicated in the needs prediction data.

13. The one or more computing devices of claim 12, further configured to:
determine a first percentage of EV drivers in the particular region that qualify as essential drivers; and
determine a second percentage of EV drivers in the particular region that qualify as opportunistic drivers; and
wherein the needs prediction data is based, at least in part, on the first percentage and the second percentage.

14. The one or more computing devices of claim 13, wherein the needs prediction data includes information about:
a number of charging stations needed in the particular region;
a location of one or more charging stations needed in the particular region; and
a type of one or more charging stations needed in the particular region.

15. The one or more computing devices of claim 12, wherein the prediction is for a particular time in the future, and wherein the one or more computing devices are further configured to:
predict the number of EV drivers that will be in the particular region at the particular time based on a current number of EV users in the particular region and an EV adoption model.

16. The one or more computing devices of claim 12, further configured to:
display user interface controls for selecting a set of one or more optimization factors from a plurality of optimization factors supported by the mobility simulation;
receive user input that selects a particular set of one or more optimization factors;
wherein the mobility simulation generates the needs prediction data based on the particular set of one or more optimization factors.

17. A non-transitory computer readable medium comprising instructions executable by a processor to:
obtain region-specific information associated with the particular region;
wherein the region-specific information includes a number of EV drivers in the particular region;
generate needs prediction data that indicates estimated EV charge needs among the population by applying the region-specific information to a mobility simulation of electrical vehicle drivers in the particular region;
wherein the mobility simulation comprises a plurality of probability distribution functions;
based on the needs prediction data, generate, on a display device of a computing device, a display that suggests a plurality of locations at which to place EV charging stations within the particular region to satisfy the estimated EV charge needs indicated in the needs prediction data.

18. The non-transitory computer readable medium of claim 17, wherein the instructions, when executed by the processor, further:
determine a first percentage of EV drivers in the particular region that qualify as essential drivers; and
determine a second percentage of EV drivers in the particular region that qualify as opportunistic drivers; and
wherein the needs prediction data is based, at least in part, on the first percentage and the second percentage.

19. The non-transitory computer readable medium of claim 18, wherein the needs prediction data includes information about:
a number of charging stations needed in the region;
a location of one or more charging stations needed in the region; and
a type of one or more charging stations needed in the region.

20. The non-transitory computer readable medium of claim 17, wherein the prediction is for a particular time in the future, and wherein the instructions, when executed by the processor, further:
predict the number of EV drivers that will be in the particular region at the particular time based on a current number of EV users in the particular region and an EV adoption model.
